(19) United States
(12) Patent Application Publication
(10) Pub. No.: US 2019/0187018 A1
(43) Pub. Date: Jun. 20, 2019

(54) Vacuum measuring device

(71) Applicant: Beijing Chuangyu Technology Co., Ltd, Beijing (CN)

(72) Inventors: Qingsong ZHAO, Beijing (CN); Jianhui NAN, Beijing (CN)

(21) Appl. No.: 16/106,014

(22) Filed: Aug. 21, 2018

(30) Foreign Application Priority Data
Dec. 15, 2017 (CN) 201711353301.2

(51) Int. Cl. G01L 19/04; G01L 21/02; G01L 9/00

(52) U.S. Cl. CPC G01L 19/04; G01L 9/0072; G01L 21/02

(57) ABSTRACT

Embodiments of the present disclosure relate to a technical field of vacuum gauges, and more particularly to a vacuum measuring device. The vacuum measuring device includes a pre-stage chamber and a vacuum gauge provided in sequence along a pressure conduction direction. The pre-stage chamber is communicated with the vacuum gauge. A pre-stage diaphragm is provided in the pre-stage chamber. A measurement diaphragm is provided in the vacuum gauge. A pressure conduction chamber is formed between the pre-stage diaphragm and the measurement diaphragm. The pressure conduction chamber is filled with a pressure conduction fluid.

### TECHNICAL FIELD

Embodiments of the present disclosure relate to a technical field of vacuum measurement, and more particularly to a vacuum measuring device.

### BACKGROUND

Today, in the rapid development of the semiconductor industry, the solar industry, the LED industry and the LCD industry, toxic materials, flammable and explosive materials and corrosive materials are widely used. These materials are deposited on a vacuum reaction chamber and a vacuum exhaust pipeline of production equipment in large quantities. Some low-melting by-products are also deposited in large quantities. These materials are easily deposited inside a vacuum gauge mounted in the vacuum reaction chamber or the vacuum exhaust pipeline, seriously affecting the vacuum measurement accuracy and affecting the service life of the vacuum gauge. Once the vacuum gauges on the equipment malfunction, old ones must be replaced by new ones, and few maintenance personnel are willing to contact these vacuum gauges with highly toxic deposits. For certain equipment which must be operated in a severe vacuum environment and must use a vacuum gauge, the vacuum gauge has become a luxury consumable. It is a nuisance for many equipment manufacturers and factories.

Ordinary vacuum gauges are suitable for the detection of a clean vacuum environment, such as the vacuum degree of nitrogen or air environment container. If there is corrosive gas in the vacuum environment, a measurement diaphragm of the vacuum gauge will be corroded, thereby affecting the detection of the vacuum degree; if there are easily deposited materials in the vacuum environment, these materials will be slowly deposited on the inner wall of a detection chamber of the vacuum gauge and the measurement diaphragm of the vacuum gauge, thereby resulting in blockage of an airflow channel of a knot of the vacuum gauge, causing the deformation of the measurement diaphragm of the vacuum gauge and the capacitance variability of the measurement diaphragm and a precision capacitor analysis element, and affecting the detection accuracy; and if the detection chamber is filled with high temperature gas, the high temperature gas easily transfers heat to the measurement diaphragm of the vacuum gauge, thereby causing the deformation of the measurement diaphragm of the vacuum gauge, affecting the measurement accuracy, or burning out the capacitor analysis element of the vacuum gauge.

At present, there are corrosion-resistant vacuum gauges and high temperature-resistant vacuum gauges on the market, but the price is more than 10 times that of ordinary vacuum gauges, and the highest temperature resistance is generally not more than 200° C. There has been no real deposition-resistant vacuum gauge on the market. Now the generation of deposits in the vacuum gauge is reduced only by increasing the working temperature of the vacuum gauge, but the maximum heating temperature is not more than 200° C. Once deposition occurs inside the detection chamber of the vacuum gauge, the vacuum gauge is required to be returned to the factory for cleaning and maintenance, which is time-consuming, laborious and costly.

### SUMMARY

### (1) Technical Problem to be Solved

The technical problem to be solved by some embodiments of the present disclosure is a problem that deposits are easily generated on a measurement diaphragm of the existing vacuum gauge measuring device, which affects the measurement accuracy and is difficult to work under extreme working conditions such as high temperature and corrosion.

### (2) Technical Solution

In order to solve the above technical problem, some embodiments of the present disclosure provide a vacuum measuring device. The vacuum measuring device includes a pre-stage chamber and a vacuum gauge provided in sequence along a pressure conduction direction. The pre-stage chamber is communicated with the vacuum gauge. A pre-stage diaphragm is provided in the pre-stage chamber. A measurement diaphragm is provided in the vacuum gauge. A pressure conduction chamber is formed between the pre-stage diaphragm and the measurement diaphragm. The pressure conduction chamber is filled with a pressure conduction fluid.

In an exemplary embodiment, the pre-stage chamber is communicated with the vacuum gauge through a pipeline.

In an exemplary embodiment, the pipeline includes a spiral pipeline and a linear pipeline.

In an exemplary embodiment, the pipeline is provided with a heat radiator.

In an exemplary embodiment, the heat radiator comprises a plurality of fins distributed uniformly.

In an exemplary embodiment, the pre-stage chamber is provided with a filling port of a pressure conduction fluid.

In an exemplary embodiment, a capacitor, a capacitor analysis element and an input/output unit are also provided in the vacuum gauge. The capacitor and the pressure conduction fluid are provided on two sides of the detection diaphragm respectively. The capacitor analysis element is connected with the capacitor, and is connected with the input/output unit through an electrode.

In an exemplary embodiment, a heat insulation baffle is provided at a junction between the vacuum gauge and the pipeline.

In an exemplary embodiment, the vacuum measuring device further includes a getter provided in the vacuum gauge.

In an exemplary embodiment, the vacuum measuring device further includes a heater configured to heat the pre-stage chamber, and a heating temperature does not more than 500° C.

ln an exemplary embodiment, the pressure conduction fluid is glycerol or silicone oil.

In an exemplary embodiment, the pipeline includes a spiral pipeline and two linear pipelines, and the spiral pipeline is provided between the two linear pipelines communicated with the pre-stage chamber and the vacuum gauge respectively.

### (3) Beneficial Effect

The above technical solution of some embodiments of the present disclosure has the following advantages. The pressure conduction fluid filled between the pre-stage diaphragm and the measurement diaphragm in some embodiments of the present disclosure can be used in a vacuum environment with corrosive gas, thereby avoiding the problem that the measurement diaphragm of the vacuum gauge is corroded, and also avoiding the problem of influence on the detection accuracy of the vacuum degree due to the deformation of the measurement diaphragm caused by the deposition of easily deposited materials in the vacuum environment on an inner wall and the measurement diaphragm of the vacuum gauge. By providing the pre-stage chamber in advance, even if the deposited materials cause blockage in an inlet of the pre-stage chamber and cause the deformation of the pre-stage diaphragm, the detection accuracy cannot be affected. Even if corrosive gas or high temperature gas causes damage to the pre-stage diaphragm, the pre-stage diaphragm provided in the pre-stage chamber can be conveniently replaced, and the subsequent vacuum gauge cannot be affected. The present disclosure can also be used in a vacuum environment filled with high temperature gas, and can avoid the problem that the measurement accuracy is affected or a capacitor of the vacuum gauge is burnt out due to the deformation of the measurement diaphragm caused by transferring heat from the high temperature gas to the measurement diaphragm. Therefore, some embodiments of the present disclosure are suitable for vacuum degree measurement not only in a normal environment, but also under extreme conditions.

Besides the above-described technical problem to be solved by the present disclosure, the technical features of the technical solution and the advantages brought by these technical features of the technical solution, other technical features of the present disclosure and advantages brought by these technical features will be further illustrated with reference to the accompanying drawings.

### BRIEF DESCRIPTION OF THE DRAWINGS

FIG. 1 is a schematic structure diagram of a vacuum gauge measuring device according to an embodiment of the present disclosure; and

FIG. 2 is a schematic structure diagram of a pipeline of a vacuum gauge measuring device according to an embodiment of the present disclosure.

In the drawings, 1, pre stage chamber; 2, vacuum gauge; 3, pipeline; 4, heat radiator; 5, getter; 6, electrode; 7, pre-stage connecting pipeline; 8, pressure conduction fluid; 11, pre-stage diaphragm; 12, filling port; 21, measurement diaphragm; 22, capacitor; 23, capacitor analysis element; 24, input/output unit; 25, heat insulation baffle; 31, spiral pipeline; 32, linear pipeline.

### DETAILED DESCRIPTION

In order to make the objectives, technical solutions and advantages of the embodiments of the present disclosure more clearer, the technical solutions in the embodiments of the present disclosure will be clearly and completely described herein below with the drawings in the embodiments of the present disclosure. Obviously, the described embodiments are only part of the embodiments of the present disclosure, not all of the embodiments. On the basis of the embodiments of the present disclosure, all other embodiments obtained on the premise of no creative work of a person of ordinary skill in the art fall within the scope of protection of the present disclosure.

In the descriptions of the present disclosure, unless otherwise specified and limited, it should be noted that terms “mounting”, “mutual connection” and “connection” should be generally understood. For example, the term may be fixed connection, or detachable connection or integrated connection, may be mechanical connection or electrical connection, may be direct connection, may be indirect connection through an intermediate, or may be internal communication between two elements. A person of ordinary skill in the art may understand specific meanings of the above terms in the present disclosure according to specific situations.

In addition, in the descriptions of the present disclosure, unless otherwise specified and limited, “multiple”, “multiple pieces” and “multiple groups” mean two or more, and “several”, “several pieces” and “several groups” mean one or more.

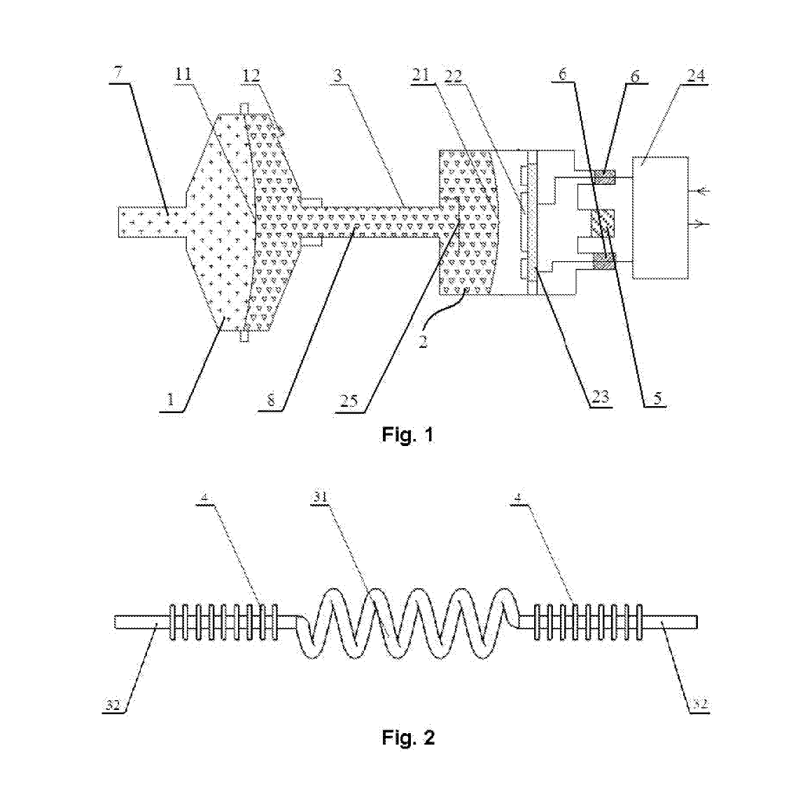

As shown in FIG. 1, a vacuum measuring device provided according to an embodiment of the present disclosure includes a pre-stage chamber 1 and a vacuum gauge 2 provided in sequence along a pressure conduction direction. The pre-stage chamber 1 is communicated with the vacuum gauge 2. A pre-stage diaphragm 11 is provided in the pre-stage chamber 1. A measurement diaphragm 21 is provided in the vacuum gauge 2. A pressure conduction chamber is formed between the pre-stage diaphragm 1 and the measurement diaphragm 21. The pressure conduction chamber is filled with a pressure conduction fluid 8.

According to the vacuum measuring device of the present disclosure, the related vacuum'gauge 2 is communicated with the pre-stage chamber 1 having the pre-stage diaphragm 11, the pressure conduction fluid 8 is filled between the pre-stage diaphragm 11 and the measurement diaphragm 21 in the vacuum gauge 2, an inlet of the pre-stage chamber 1 is directly connected to a vacuum chamber to be measured through a pre-stage connecting pipeline 7, the pressure of the vacuum chamber is transmitted to the pre-stage diaphragm 11 through the pre-stage connecting pipeline 7, and the pre-stage diaphragm 11 transmits the chamber pressure to the measurement diaphragm 21 through the pressure conduction fluid 8, thereby causing deformation of the measurement diaphragm 21, which in turn causes a change in the detected value of the subsequent detection element in the vacuum gauge 2, so as to determine the vacuum degree of the vacuum chamber.

The pressure conduction fluid 8 filled between the pre-stage diaphragm 11 and the measurement diaphragm 21 in the present disclosure can be used in a vacuum environment with corrosive gas, thereby avoiding the problem that the measurement diaphragm 21 of the vacuum gauge 2 is corroded, and also avoiding the problem of influence on the detection accuracy of the vacuum degree due to the deformation of the measurement diaphragm 21 caused by the deposition of easily deposited materials in the vacuum environment on the inner wall and the measurement diaphragm 21 of the vacuum gauge 2. By providing the pre-stage chamber 1 in advance, even if the deposited materials cause blockage in an inlet of the pre-stage chamber 1 and cause the deformation of the pre-stage diaphragm 11, the detection accuracy cannot be affected. Even if corrosive gas or high temperature gas causes damage to the pre-stage diaphragm 11, the pre-stage diaphragm 11 provided in the pre-stage chamber 1 can be conveniently replaced, and the subsequent vacuum gauge 2 cannot be affected. The present disclosure can also be used in a vacuum environment filled with high temperature gas, and can avoid the problem that the measurement accuracy is affected or a capacitor 22 of the vacuum gauge 2 is burnt out due to the deformation of the measurement diaphragm 21 caused by transferring of heat from the high temperature gas to the measurement diaphragm 21. Therefore, the present disclosure is suitable for vacuum degree measurement not only in a normal environment, but also under extreme conditions.

Wherein, as shown in FIG. 2, the pre-stage chamber 1 is communicated with the vacuum gauge 2 through a pipeline 3. Wherein, the pipeline 3 includes a spiral pipeline 31 and a linear pipeline 32. The pipeline 3 for communicating the pre-stage chamber 1 and the vacuum gauge 2 is spirally formed to prevent heat from reaching the vacuum gauge 2 through the pressure conduction fluid 8 to affect the detection accuracy of the vacuum gauge 2 and damage the vacuum gauge 2. In the present embodiment, the pipeline 3 is all or a part of an outer wall of a pressure conduction chamber. Both ends of the spiral pipeline 31 are connected with two linear pipelines 32 respectively, and the two linear pipelines 32 connect the pre-stage chamber 1 and the vacuum gauge 2 respectively.

Specifically, the pipeline 3 is provided with a heat radiator 4, thereby facilitating further heat dissipation. The heat radiator 4 may be a radiator, a fin, or the like. In an exemplary embodiment, the heat radiator 4 includes a plurality of fins, which are distributed uniformly on the linear pipeline 32.

Wherein, the pre-stage chamber 1 is provided with a filling port 12 for the pressure conduction fluid 8. After the device is used, the pressure conduction fluid 8 between the pre-stage diaphragm 11 and the measurement diaphragm 21 can reduce or generate impurities, and can be filled and replaced through the filling port 12 for the pressure conduction fluid 8 on the pre-stage chamber 1 to ensure that the pressure conduction fluid 8 is filled between the pre-stage diaphragm 11 and the measurement diaphragm 21, so that the vacuum pressure received by the pre-stage diaphragm 11 can be accurately transmitted to the measurement diaphragm 21.

In addition, the pre-stage chamber 1 can be opened from the pre-stage diaphragm 11 to facilitate cleaning or replacement of the pre-stage diaphragm 11.

Further, a capacitor 22, a capacitor analysis element 23 and an input/output unit 24 are also provided in the vacuum gauge 2. The capacitor 22 and the pressure conduction fluid 8 are provided on two sides of the detection diaphragm 21 respectively. The capacitor analysis element 23 is connected to the capacitor 22, and is connected to the input/output unit 24 through an electrode 6. The capacitor analysis element 23 obtains the capacitance change of the capacitor 22 and introduces it into the input/output unit 24 through two electrodes 6. The input/output unit 24 is connected to external equipment to detect the vacuum degree of the vacuum chamber. The change of the vacuum degree in the vacuum chamber causes different degrees of deformation of the measurement diaphragm 21. The capacitor analysis element 23 obtains the capacitance value change of the capacitor 22, and outputs a capacitance value change signal to the input/output unit 24, the input/output unit 24 sends the signal to the external equipment, and the external equipment processes the signal to obtain the vacuum degree of the vacuum chamber.

Wherein, a heat insulation baffle 25 is provided at a junction between the vacuum gauge 2 and the pipeline 3. The heat insulation baffle 25 is designed in the vacuum gauge 2 to further prevent heat radiation from directly entering the vacuum gauge 2 and prevent large deposited particles from directly entering the vacuum gauge 2.

The vacuum measuring device of the present disclosure further includes a getter 5. The getter 5 is provided in the vacuum gauge 2. The getter 5 is provided to ensure the absolute vacuum degree in the vacuum gauge 2.

The vacuum measuring device of the present disclosure further includes a heater. The heater heats the pre-stage chamber 1, and the heating temperature does not more than 500° C. In order to prevent deposited materials in the pre-stage chamber 1 from generating, the pre-stage chamber 1 can be heated up to 500° C. The high temperature of 500° C. can prevent most of the easily-volatile materials from depositing. Even if a small amount of deposits are generated, it is easier to maintain the pre-stage chamber 1 than the vacuum gauge 2.

Wherein, the pressure conduction fluid 8 is glycerol or silicone oil. According to different use environments of the vacuum gauge 2, materials with different boiling points such as silicone oil and glycerin can be selected. The vacuum gauge 2 applying the glycerin pressure conduction fluid can measure the vacuum degree of a high temperature chamber of 150-180° C. The vacuum gauge 2 applying the silicone oil pressure conduction fluid can measure the vacuum degree of a high temperature chamber of 200-300° C. The pressure conduction fluid that has been tested can withstand the vacuum degree of a high temperature chamber of 500° C. at most. When the pressure conduction fluid adopts a high temperature-resistant fluid, it can be used in a vacuum environment with high temperature gas, and the problem that the measurement accuracy is affected or the capacitor 22 of the vacuum gauge 2 is burnt out due to the deformation of the measurement diaphragm 21 caused by transferring of heat from the high temperature gas to the measurement diaphragm 21 can be avoided.

In use, in order to adapt to corrosive vacuum measurement occasions, the pre-stage diaphragm 11 can be made of a corrosion-resistant material, and different materials can be selected according to the type of the resistance to corrosive gas, and non-metallic materials can also be used. In extreme occasions, the vacuum gauge 2 can be protected by sacrificing the pre-stage diaphragm 11.

To sum up, the pressure conduction fluid filled between the pre-stage diaphragm and the measurement diaphragm in the present disclosure can be used in a vacuum environment with corrosive gas, thereby avoiding the problem that the measurement diaphragm of the vacuum gauge is corroded, and also avoiding the problem of influence on the detection accuracy of the vacuum degree due to the deformation of the measurement diaphragm caused by the deposition of easily deposited materials in the vacuum environment on the inner wall and the measurement diaphragm of the vacuum gauge. By providing the pre-stage chamber in advance, even if the deposited materials cause blockage in an inlet of the pre-stage chamber and cause the deformation of the pre-stage diaphragm, the detection accuracy cannot be affected. Even if corrosive gas or high temperature gas causes damage to the pre-stage diaphragm, the pre-stage diaphragm provided in the pre-stage chamber can be conveniently replaced, and the subsequent vacuum gauge cannot be affected. The present disclosure can also be used in a vacuum environment filled with high temperature gas, and can avoid the problem that the measurement accuracy is affected or a capacitor of the vacuum gauge is burnt out due to the deformation of the measurement diaphragm caused by transferring of heat from the high temperature gas to the measurement diaphragm. Therefore, the present disclosure is suitable for vacuum degree measurement not only in a normal environment, but also under extreme conditions.

It shall be, finally, noted that: the above embodiments are merely intended to illustrate the technical solutions of the present disclosure and do not limit the technical solutions; although the present disclosure is illustrated in detail with reference to the above embodiments, a person of ordinary skill in the art shall understand that they can still modify the technical solutions recorded by the above embodiments or can equivalently replace some of the technical features; and these modifications or replacements do not make the essences of corresponding technical solutions depart from the spirit and scope of the technical solutions in each embodiment of the present disclosure.

What is claimed is:

1. A vacuum measuring device, comprising a pre-stage chamber and a vacuum gauge provided in sequence along a pressure conduction direction, wherein the pre-stage chamber is communicated with the vacuum gauge; a pre-stage diaphragm is provided in the pre-stage chamber; a measurement diaphragm is provided in the vacuum gauge; a pressure conduction chamber is formed between the pre-stage diaphragm and the measurement diaphragm; and the pressure conduction chamber is filled with a pressure conduction fluid.

2. The vacuum measuring device as claimed in claim 1, wherein the pre-stage chamber is communicated with the vacuum gauge through a pipeline.

3. The vacuum measuring device as claimed in claim 2, wherein the pipeline comprises a spiral pipeline and a linear pipeline.

4. The vacuum measuring device as claimed in claim 2, wherein the pipeline is provided with a heat radiator.

5. The vacuum measuring device as claimed in claim 4, wherein the heat radiator comprises a plurality of fins distributed uniformly.

6. The vacuum measuring device as claimed in claim 1, wherein the pre-stage chamber is provided with a filling port of the pressure conduction fluid.

7. The vacuum measuring device as claimed in claim 1, wherein a capacitor, a capacitor analysis element and an input/output unit are also provided in the vacuum gauge, the capacitor and the pressure conduction fluid are provided on both sides of the measurement diaphragm respectively, and the capacitor analysis element, is connected with the capacitor, and is connected with the input/output unit through an electrode.

8. The vacuum measuring device as claimed in claim 2, wherein a heat insulation baffle is provided at a junction between the vacuum gauge and the pipeline.

9. The vacuum measuring device as claimed in claim 1, wherein the vacuum measuring device further comprises a getter provided in the vacuum gauge.

10. The vacuum measuring device as claimed in claim 1, wherein the vacuum measuring device further comprises a heater configured to heat the pre-stage chamber, and a heating temperature does not more than 500° C.

11. The vacuum measuring device as claimed in claim 1, wherein the pressure conduction fluid is glycerol or silicone oil.

12. The vacuum measuring device as claimed in claim 2, wherein the pipeline comprises a spiral pipeline and two linear pipelines, and the spiral pipeline is provided between the two linear pipelines communicated with the pre-stage chamber and the vacuum gauge respectively.
